(19) United States
(12) Patent Application Publication
(10) Pub. No.: US 2008/0256004 A1
(43) Pub. Date: Oct. 16, 2008

(54) LOANS FOR PROFESSIONAL SERVICES

(76) Inventor: Peter Nelson Schmitt, Snoqualmie, WA (US)

Correspondence Address: BLACK LOWE & GRAHAM, PLLC, 701 FIFTH AVENUE, SUITE 4800, SEATTLE, WA, 98104, US

(21) Appl. No.: 12/102,737

(22) Filed: Apr. 14, 2008

Related U.S. Application Data
(60) Provisional application No. 60/911,813, filed on Apr. 13, 2007.

(51) Int. Cl. G06Q 90/00

(52) U.S. Cl. 705/500

(57) ABSTRACT

A system and method for providing loans to third parties based on the third parties' request to obtain funding for professional services includes loan financing that replaces a vast and existing market of underwritten unsecured debt. The system provides an amount of secured debt issued on repeatable underwriting standards and converts the debt to collateralized debt obligations which may be arranged in packages as transferable financial instruments that may be purchased by investors. The loans to the third parties may be provided with associated default risks depending in part on whether a security interest is taken by the lender. Further, the payments made to the professional service provider may be discounted based at least in part on when the payment is made by the lender to the professional service provider.

### PRIORITY

This application claims priority to U.S. Provisional Patent Application No. 60/911,813 filed on Apr. 13, 2007, the subject matter of which is incorporated herein by reference in its entirety.

### FIELD OF THE INVENTION

The present invention relates generally to financial services, and more specifically, to providing secured loans to entities obligated to make payments to or seeking the services of a professional service provider.

### BACKGROUND OF THE INVENTION

Small to medium-sized businesses face many demands on their working capital. For a well-managed and growing business, many expenses are funded out of receipts while others are met by a combination of short, medium and long-term borrowing. Such a business, for example, may obtain a revolving line of credit from a bank so it can meet bimonthly payroll despite accounts-receivable payments being received at the end of the month. The revolving line of credit may be structured with a 30-day maturity and an interest rate fluctuating according to market rates such as the Federal funds rate or London Interbank Offered Rates (LIBOR). The revolving loan could be backed by the company's accounts receivable posted as collateral.

At the opposite extreme, construction of a new headquarters building might be financed by a loan with a maturity decades into the future, a fixed interest rate, and the building itself posted as collateral.

Companies find similar access to credit for many other standard business expenses. Such credit allows a company to pay for a tangible or intangible asset over the useful life span of the asset.

Financial institutions who routinely lend to small and medium-sized businesses are often repeat players in the area in which they lend. They have developed experience in judging the risk of default by a company, as well as the value of collateral. They are also familiar with state laws on perfecting security interests in collateral under Article 9 of the Uniform Commercial Code (UCC Art. 9).

While small and medium-sized businesses have ready access to sophisticated credit markets for many of the usual expenses which challenge a growing business, one service routinely provided to business presents unique challenges to companies, lenders, and service providers.

For any business, the required utilization of professional service providers, and in particular legal counsel, represents a real and sometimes significant cost of doing business. In many instances, a company's forward business strategy requires significant interim, and in some cases extended, expenditures for third-party professional services. For many companies, the impact of these expenses can often strain and overextend operating budgets and borrowing capacities. For example, unexpected or unbudgeted legal expenses, such as defending a lawsuit, prosecuting a patent, or defending a regulatory investigation, can put a significant strain on already tight budgets.

Because of the strain of high short-term costs, many companies are unable to fully pay obligations to lawyers or other professional service providers promptly when due. In doing so, the company becomes a debtor for the professional services rendered and compels the service provider to become its lender. Financial institutions which loan to businesses face great difficulty in determining whether or not to fund a loan for professional services.

Evolving regulation in the banking industry has caused a dramatic shift in the way that lenders are able to meet the working capital needs of firms that require significant professional services. The increasingly conservative lending environment brought on by greater regulation and an increased focus on risk management has led to fewer banks willing to finance what they perceive to be “riskier” expenditures on vital professional services.

These loans are perceived as riskier to financial institutions for a number of reasons. Few lenders are repeat players in this area, and even fewer make multiple loans of this type to the same customer. Furthermore, even when the same customer needs more than one loan for professional services, the nature of the services—whether legal, regulatory, accounting, or some other type—is rarely so similar as to provide the lender with a track record for gauging the risk of the subsequent loan based on the performance of the first.

The lack of repeat transactions lowers the information available to a lender to help determine the risk of default on a particular loan. In credit markets, the lack of information translates into higher loan costs as the lender charges additional interest to compensate for the unknown amount of risk it takes on, in addition to interest charged which prices the known risk.

Additionally, financial institutions whose deposits from consumers are insured by the Federal Deposit Insurance Corporation (FDIC) are subject to stringent oversight and regulation. One relevant aspect of that regulation is that an FDIC-insured institution must hold back sufficient capital to hedge against the risk of default on its loan portfolio, and its regulators must agree on the determination of sufficiency. Thus, for FDIC-insured institutions, who are the primary lender to small and medium-sized businesses, the loan officer's judgment about the soundness of a particular loan is not sufficient for the loan to issue.

In the case of short-term loans received by accounts receivable or long-term loans secured by a physical building, this is no serious impediment to lending. Both accounts receivable and a physical building can be valued easily and with a measure of accuracy and objectivity based on existing models which conform to regulatory standards.

However, with a loan for professional services, it is much harder to identify relevant collateral, price the collateral, identify default risk, and price it, for both the loan officer and the regulator. And the regulatory requirements mean that the loan officer's good judgment and long-term knowledge of the customer will not substitute for identified, objective, repeatable cost and risk models.

Additionally, a lender asked to extend credit to fund a company's legal expense has significantly greater difficulty estimating the risk of the loan since both the prospective borrower and service provider cannot provide information about the litigation risk without waiving the attorney-client privilege and thereby undermining the chance of a successful conclusion to the representation.

Furthermore, because there currently exists no secondary market for loans made to companies to fund professional services, any financial institution which makes such a loan must keep the loan on its balance sheet until it is paid in full or written off. With no secondary market, if such a loan is sold, it is sold in its entirety, so that all the default risk is sold from the original lender to the purchaser. There exists no market at present for a potential investor to add liquidity to the credit market through the purchase of a fractional interest in one or more loans of this type. Additionally, different investors often have different levels of risk they are willing to take. At present, no mechanism exists to allow multiple investors to fund loans for professional services but for each investor to bear a different level of default risk and receive a correspondingly different yield on that investment. As a result of these missing elements in the current market for professional service loans, such loans are often expensive, if they can be had at all.

Thus, companies facing significant short-term expenses for professional services often are forced to spread the cost of those services over time by simply not paying the professional service provider's invoice in full when due. The result is that the professional service provider, such as a law firm, becomes a lender to its clients. However, the creditor-debtor relationship is drastically different than advisor-client relationship, and the two can be at odds with one another.

A professional services firm seeks to maintain its existing clients and secure new ones. Neither goal is achieved by attempting to compel payment of invoices that a client simply cannot afford. Furthermore, although firms, by virtue of dealing with enough late-paying clients, have become regular lenders, lending is not their area of expertise. As a result, many firms “price” all debt equally, usually in the initial retainer agreement that specifies that accounts over 30 days old will be charged a specified rate, often 1%-1.5% per month, or about 12%-18% per year.

Nonetheless, because they are first and foremost service providers, not lenders, firms routinely extend ageing on their accounts receivable. One law firm reports that litigation receivables average over 165 days to collection and that carrying accounts receivable over 200 days results in an internal cost of over 5%. In addition, many legal firm compensation plans are tied to fiscal year collections, not billings. As a result, attorneys must divert their attention to collections versus generating additional billable hours. This represents a real and considerable cost incurred by the professional services firm.

To resolve their internal cash-flow problems and attempt to ease some of the inevitable strain with clients that results, some firms seek bank loans against A/R represented by past due client accounts. However, although financing is available for many law firms, lenders often have strict requirements about the quality and aging of the receivables they are willing to lend against. As a result, law firms remain lenders to their clients and in order to maintain the client relationship, often realize extended aging and a higher percentage of write-offs on their receivables.

There exist two types of financing options geared specifically towards smoothing the internal cash-flow of plaintiff-based law practices: pre-settlement funding and post-settlement funding. While both methods assist the professional services provider in smoothing cash flow and lowering the cost of collections, neither method assists client entities in lowering, smoothing, or extending legal costs.

With post-settlement funding, the professional services firm sells the receivable account after the legal action has been settled. The factoring company will often purchase the receivable at a significant discount and collect directly from the client.

There are several types of pre-settlement financing, all of which involve the financing of on-going litigation costs to the firm, rather than buying the receivable after a case has been completed or settlement awarded. In these cases, all lending is made directly to the law firm with no benefit to the client.

The lender bears a high risk in pre-settlement financing because it has no connection to the client and therefore cannot directly assess the client's overall financial condition. Furthermore, because state legal ethics rules (often modeled on or drawn directly from the American Bar Association's Rules of Professional Conduct, or RPCs) limit the amount of information about the case and legal strategy that the attorney and client can share without breaching the attorney-client privilege, the lender has virtually no ability to evaluate the strength of the legal strategy or case outside of what information is available to the public.

The most common pre-settlement financing method is the purchase by a finance company of the law firm's expected fee. In this method, the financial services company has a vested party in the outcome of the case, and the finance company's return varies with the amounts of the settlement. If the plaintiff loses, the law firm does not receive any contingency and the finance company receives no payment. Underwriting the contingency case value is a unique challenge to the lender due to attorney-client privilege and confidentiality of information. Furthermore, the client receives no direct benefit with this method.

Pre-settlement financing methods also include lending money to the law firm on a case-by-case-basis. Unlike a traditional bank loan, interest and principal are not usually due until the case settles, but interest accrues over the duration of the litigation. This type of financing is accomplished either on a recourse, or more commonly, on a non-recourse loan basis. As is the case with equity investment financing, underwriting of the case value is a unique challenge to the finance company based on potential conflicts with the RPCs.

Some finance companies provide general lines of credit to law firms. They attorneys must submit each case to the finance company for approval before the firm is allowed to draw down on the line of credit. The line is generally secured by all of the firm's case value, accounts receivable, or other assets. However, this type of lending is flawed in comparison to the present invention in two capacities. First because of ethical obligations the financing only benefits the law firm. Second, most successful law firms already maintain similar operating lines with their primary lenders whose caveats and covenants do not allow additional asset based borrowing.

These two financing solutions have gained popularity and now comprise a significant sub-industry in the financial markets. The emergence of this sub-industry is primarily attributable to the rapid change in how commercial banks “risk profile” law firms, particularly litigation-centric law firms. The ever increasing regulatory constraints placed on chartered lenders, coupled with a steady decline in the interest and understanding of the inherent risks associated with the operation of professional services firms has created an unmet demand in the marketplace.

Services firms also have additional risk as lenders due to the difficulty of taking and perfecting a security interest to protect against defaults. Although firms are often permitted to take security interests to protect against default in debt obligations represented by past-due bills, it is simply not an area of expertise for most professional services firms. Additionally, for law firms, RPCs can constrain the type of security interest a firm may take.

Finally, even if a firm takes a security interest in its client's asset—a building, a patent, accounts receivable, or anything else—seizing the asset is virtually guaranteed to end the professional relationships on very bad terms, probably to the reputational detriment of the professional services firm. Thus, even if a professional services firm takes a security interest in an asset of its client, that effectively only protects the services firm in the event of client bankruptcy. Even after a bankruptcy filing, the actions of a professional advisor, and especially a law firms, will be scrutinized extremely closely when the service provider seeks to be paid ahead of unsecured creditors by virtue of its security interest in an asset.

Similarly, while a services firm can monetize the debt owed to it by late-paying clients by selling it at a discount to face value to a collection firm, such a move virtually guarantees an end to a client relationship and the possibility of harm to professional reputation.

### SUMMARY OF THE INVENTION

Similarly, while a services firm can monetize the debt owed to it by late-paying

The invention is generally directed towards a method lending and loan financing that replaces a vast and existing market of underwritten unsecured debt and replaces it with secured debt issued on repeatable underwriting standards and subsequently converted to collateralized debt obligations which can be packaged as securities for sale to or participation in and by investors whose investment in those securities complies with relevant state and federal regulations.

One aspect of the invention focuses on separating the debt burden associated with utilizing professional services from the relationship between professional services provider and client, thereby allowing a borrower to extend payment for such services over time without straining the advisor-client relationship by adding to it the contrary borrower-lender relationship. A lender may take a security interest in a loan that funds professional services without violating any applicable ethics rules or damaging a client relationship.

By dissociating the loan and the security interest backing the loan from the specific professional service provider, the lender may gauge the default risk and price the loan accordingly without requiring the borrower or professional services provider to breach nay advisor-client confidentiality.

In one embodiment, a lender packages one or more such loans and sells interests in the loan or loans to investors as a means of funding such loans. The one or more loans may have different default risks associated therewith so that investors with different appetites for risk may invest in the packaged loans.

The professional services provider, the client, and the lender preferably have mutual and exclusive duties, responsibilities, and covenants governed by separate and distinct agreements, thus allowing the lender to pursue prospective borrowers based on publicly available information about legal action accessible via court documents. Additionally or alternatively, the lender may identify and pursue potential borrowers by reviewing federal and state court document filing systems in order to receive real time status updates of any filed civil case.

Various aspects of the invention may provide benefits for both the service provider and the client. By way of example, the service provider receives payment faster, reduces the aging of receivables, does not have to serve as de facto lender to the clients, and is better able to manage client relationships, all with an object of not violating any RPCs. The client, in turn, is able to spread out the necessary payments for professional services over time, enabling better management of cash flow. Additionally, aspects of the invention may serve to remove the collections process between the service provider and the client before it could potentially impair a positive business relationship.

Advantageously, the system and methods for providing loans for professional services may allow robust returns to the lender via a combination of discounting, fees, and interest spread. In addition, the lender may reduce risk by securing the loan with corporate or personal assets and/or those of a cosigner. Further, aspects of the invention may provide a new and comprehensively unique financing solution that provides powerful new tools to lenders, professional service providers, and their clients.

In one aspect of the invention, a loan package related to a third party request for funding of professional services provided by a professional service provider includes a loan provided by a lender to a third party requesting funding for professional services. The loan includes a plurality of loan terms negotiated between the lender and the third party. A default risk may be applied to the loan as determined by the lender, where the default risk is related to a price point for the loan when the loan is configured for sale by the lender. And, the loan package includes a collateralized pool of loans in which at least one of the loans in the pool is the loan provided by the lender. The collateralized pool of loans includes debt obligations for professional services, wherein ownership rights associated with each of the loans in the collateralized pool are configurable to make at least a portion of the collateralized pool operable as a transferable financial instrument.

In another aspect of the invention, a method of providing loans to third parties based on the third parties' request to obtain funding for professional services includes the steps of (1) forming a agreement between at least one lender and at least one third party based on a desire of the at least one third party to obtain funding for professional services from a professional service provider; (2) determining a default risk to associate with each of the loans; (3) determining a price point for each of the loans based at least in part on the associated default risks; and (4) grouping the loans into a loan package having ownership rights that make the loan package operable as a transferable financial instrument.

### BRIEF DESCRIPTION OF THE DRAWINGS

The preferred and alternative embodiments of the present invention are described in detail below with reference to the following drawings:

FIG. 1 is a schematic diagram showing relationships between a third party, a lender, and a professional service provider for providing loans based on the third parties' request to obtain funding for professional services according to an embodiment of the invention;

FIG. 2 is a schematic diagram showing relationships between third parties seeking loans, lenders, professional service providers and investors for collateralization and/or securitization of the loans according to an embodiment of the invention; and

FIG. 3 is an example of a discount term agreement that may be negotiated between a lender and a professional service provider according to an embodiment of the invention.

### DETAILED DESCRIPTION OF THE PREFERRED EMBODIMENT

In the following description, certain specific details are set forth in order to provide a thorough understanding of various embodiments of the invention. In other instances, well-known structures and methods associated with loans, loan agreements, security interests, transferable financial instruments, rules, laws and regulations regarding the same, and methods of providing, securing and/or perfecting the same may not be shown or described in detail to avoid unnecessarily obscuring descriptions of the embodiments of the invention.

The following description generally relates to systems and methods for providing loans to third parties based on the third parties' desire to obtain funding for professional services. The third party may be a company, individual, or other entity identified by the lender, the professional service provider, or other entity.

Although the market for professional services in the U.S. is about $600 billion per year, with the largest segment being legal services, which generates about $130 billion per year, no financial services company has found a method to routinely provide credit to help companies meet those expenses and spread the cost of the expense over the life-span of the resulting intangible asset, as with other routine forms of financing. For example, a start-up emerging technology company might face extraordinary expenses in one or two consecutive quarters to secure a patent or technology that benefits the company for decades. But unlike a similar investment in a headquarters building, the company will be hard-pressed to find a lender to finance that expense.

Despite the almost routine state of affairs of a small-to-medium sized business owing its professional services provider for services rendered, no financial services company has found a way to fill this need and provide credit to third parties so they may obtain professional services.

One aspect of the present invention allows the third party to pay for its professional services in full, as bills become due, while maintaining a positive relationship with its professional services provider. In addition, a lender providing the desired funds to the third party may take a security interest in the loan while being permitted to access sufficient information about the third party (i.e., borrower) and the asset which secures the loan. By way of example, this approach may help the lender to determine a default risk of the loan and further determine a price point for selling the loan preferably without violating any protected confidences or providing any suspicions of impropriety or conflict of interest between the third party and the professional services provider. In addition to the aforementioned aspects, the lender may seek the ability to fund these types of loans by packaging them into transferable financial instruments and then selling those instruments to investors. The transferable financial instruments may be segregated and grouped with an averaged default risk. By way of example, these and other aspects of the invention may provide “gap” financing to third parties whose circumstances require significant interim expenditures for professional services, while providing for the securitizing and transferring of such loans.

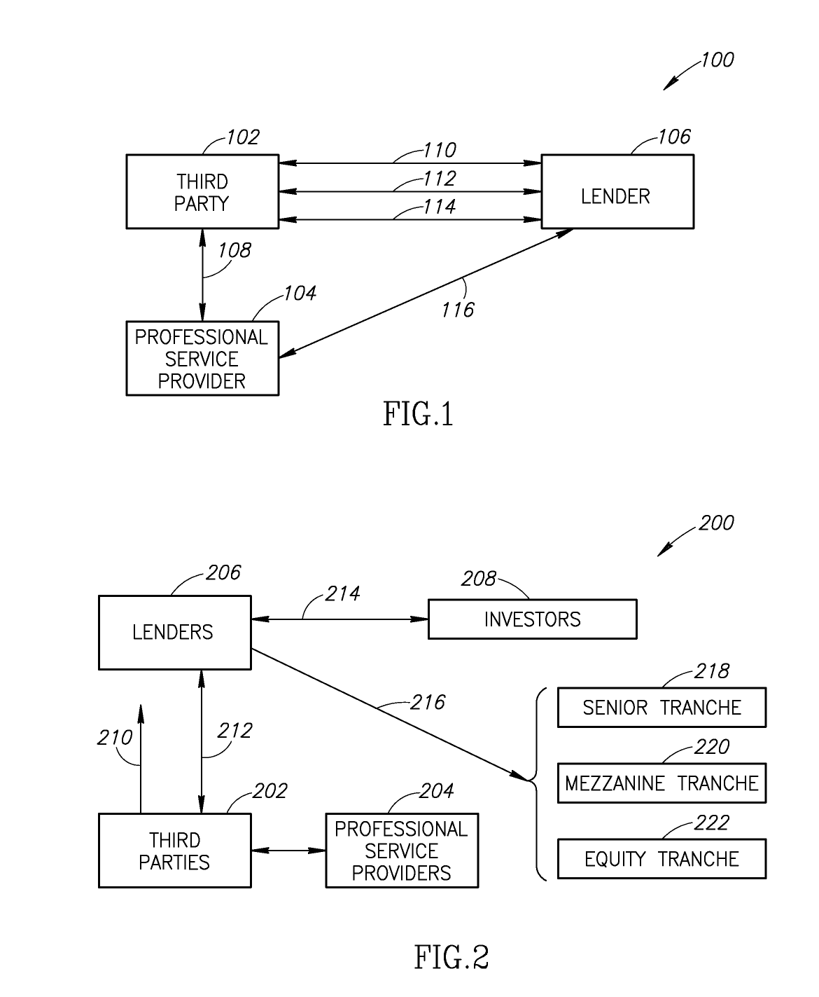

FIG. 1 shows relationships 100 between a third party (i.e., borrower) 102, a professional services provider 104 and a lender or financing entity 106. In the illustrated relationship 100, the third party 102 desires professional services from the professional services provider 104, so the third party 102 enters into a first agreement 108 with the provider 104, commonly referred to as a representation agreement when legal services are involved, in which the third party 102 agrees to the fees that may be charged by the provider 104 for the professional services. The third party 102 also enters into a second agreement 110 with the lender 106 in which the lender 106 agrees to advance the funds either as one lump sum or as needed by the third party 102 to pay for the professional services rendered by the provider 104. Nevertheless, the third party 102 agrees to repay the lender 106 through periodic or installment payments on the debt incurred.

Further, the illustrated embodiment shows a third agreement 112, which may take the form of a security interest 112, entered into between the third party 102 and the lender 106. The security interest 112 is shown as an independent agreement; however it may be formed as one or more loan terms in the second agreement between the lender 106 and the third party 102. The security interest 112 may be perfected (as defined under Article 9 of the UCC) by the lender 106 in selected assets of the third party 102 to protect the lender 106 in whole or in part from the risk of default. The selected assets may correspond to or be independent from the professional services provided by the professional services provider 104.

In one embodiment, the lender 106 may enter into another agreement 114 with the third party 102 and the provider 104 that provides authorization from the third party 102 for the lender 106 to receive bills or invoices directly from the professional service provider 104 for the professional services rendered. In turn, the agreement 114 may further authorize the lender 106 to pay the provider 104 directly and within a certain amount of time. In such an arrangement, the invoices and the amount paid to the provider 104 could be reported to the third party 102 during or after the certain amount of time.

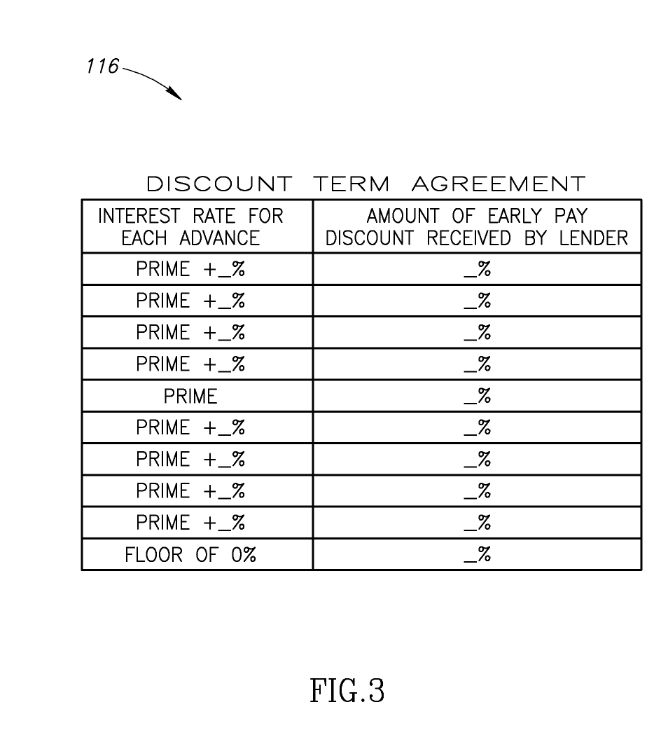

Another aspect of the illustrated embodiment may include the third party 102 entering into a discount term agreement 116 (FIG. 3) as between the third party 102 and the professional service provider 104. The discount term agreement 116 may operate to invoke a discount on at least some of the cost of the professional services rendered. The discount may be on a per service basis depending on the type of professional service rendered, may be a blanket discount rate applied to all services, or may take other forms as negotiated between the third party 102 and the professional service provider 104, which is enabled by the discount pricing extended to the third party 102 by the lender 106 as a result of a pre-set discount pricing scheme included in the promissory note. The pre-set discount pricing scheme is achieved without direct participation by the lender 106. In one embodiment, the discount may be based on a selected rate coupled with a discount percentage that corresponds to payment. The selected rate may take the form of a prime rate used by banks, a sub-prime rate, or some other rate that may or may not be related to the prime rate. Further, payment may be when the lender 106 transfers the payment, when the professional service provider 104 receives the payment, or some other agreed upon event. One purpose of the discount term agreement 116 is to reduce the amount of the professional services from a normal or standard rate in correlation with when the professional services provider 104 receives payment. By way of example, for legal services this may take the form of reducing an attorney's billing rate through operation of the discount term sheet 116.

FIG. 2 shows relationships 200 between one or more third parties 202, one or more professional services providers 204, one or more lenders 206, and at least one investor 208. As a result of the agreements described above, the lender 14 directs the principal 120 of one or more loans to any of the one or more borrowers 10 or one or more providers 12. Preferably, the invention may operate more cost effectively in the aggregate in which multiple entities are involved, for example multiple third parties 202, multiple professional service providers 204, multiple lenders 206, and multiple investors 208, however the invention is not limited to such and may operate with only single entities in any combination. For purposes of clarity, the entities will be referred to hereinafter in their plural sense.

The third parties 202 pays principal and interest on the loans by making periodic payments 210 to the lenders 206 in accordance with the terms of the third party-lender agreements 212, which were described above with respect to FIG. 1 as agreement 110.

One purpose of the relationships 200 shown in the illustrated embodiment allows the lender 206 to create interests or collateralized debt obligations (CDOs) 214 from the loans taken by the third parties 202 to fund the professional services from the professional service providers 204. The CDOs may take the form of secured current, secured future, unsecured current, and/or unsecured future debt obligations. Each CDO may include an associated risk factor where the investors 208 may purchase the same based on the risk factor. By purchasing the CDOs 214, the investors 208 receive the right to receive periodic payments 216 from the lender 206. In turn, the lender 206 funds those periodic payments 216 from the principal and interest payments 210 made by the third parties 202.

Advantageously, the relationships 200 provide a conduit for accredited private equity “funds”, “pools” and backed financial institutions to support business operations in an already large and growing service sector of the economy while not compromising professional service providers rules of ethical and professional conduct while under compliance with federal and state regulations, such as, but not limited to securities regulations. The CDOs operate as receivables through the issuance of subordinated notes to the investors 208 and provide a mechanism to sell ownership and participation in the CDOs, which may otherwise be referred to as transferable financial instruments.

Those CDOs receive principal and interest payments according to the terms through which the CDOs were generated. The investors 208 may purchase CDOs with more or less default risk according to their appetite for such risk. Thus the investor 208 seeking low risk of default may receive CDOs that are not subordinated with respect to the CDOs owned by other investors 208. For example, the investor 208 seeking low risk may select CDOs corresponding to a senior tranche 218, which refers to one of several related securitized bonds offered as part of the same deal. Likewise, an investor 208 with greater appetite for risk may select CDOs corresponding to a mezzanine tranche 220, which would pay out before most other tranches. Further, an investor 208 with a high appetite for risk may select CDOs corresponding to an equity tranche 222, which is paid after both the senior tranche 218 and the mezzanine tranche 220.

The various embodiments and aspects of the invention described above may advantageously allow robust returns to the investors and lenders through a combination of discounting, fees, and interest spread. In addition, the invention may reduce risk through collateralization and/or securitization of loans provided to third parties seeking professional services from professional service providers. The loans, in turn, may be secured with corporate or personal assets and/or a cosigner.

By way of example, one embodiment of the invention in which the professional service provider is a law firm may include a client agreement with five binding working documents, as follows: (1) a loan agreement; (2) a loan advance request form; (3) a discount payment term sheet; (4) a promissory note; and (5) a security and/or personal guarantee agreement. Further, a web site and payment remittance portal may be employed to track payments from the client to the lender and/or from the lender to the professional service provider. By way of example, the web site may operate to provide a secure, electronic-based infrastructure that allows the client to view aspects of the funding process in real time, provides the client access to current account information and billing statements, and may serve as a marketing and promotional tool for display and access to published materials, contact information, and customer and professional service provider inquiries.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined by reference to the claims that follow.

1. A loan package related to a third party request for funding of professional services provided by a professional service provider, the loan package comprising:
a loan provided by a lender to a third party requesting funding for professional services, the loan having a plurality of loan terms negotiated between the lender and the third party;
a default risk applied to the loan as determined by the lender, the default risk related to a price point for the loan when the loan is configured for sale by the lender; and
a collateralized pool of loans in which at least one of the loans in the pool is the loan provided by the lender, the collateralized pool of loans includes debt obligations for professional services, wherein ownership rights associated with each of the loans in the collateralized pool are configurable to make at least a portion of the collateralized pool operable as a transferable financial instrument.

2. The loan package of claim 1, further comprising a discount payment term sheet agreed upon between the lender and the professional service provider.

3. The loan package of claim 1, wherein at least one loan term includes a security interest taken by the lender to secure at least a portion of the loan.

4. The loan package of claim 3, wherein the security interest is entered into independent of the professional service provider.

5. The loan package of claim 1, wherein the debt obligations include current debt obligations.

6. The loan package of claim 1, wherein the debt obligations include future debt obligations.

7. The loan package of claim 1, wherein ownership rights includes participation rights.

8. The loan package of claim 1, wherein the transferable financial instrument includes a securities compliant financial instrument.

9. A method of providing loans to third parties based on the third parties' desire to obtain funding for professional services, the method comprising:
forming a agreement between at least one lender and at least one third party based on a desire of the at least one third party to obtain funding for professional services from a professional service provider;
determining a default risk to associate with each of the loans;
determining a price point for each of the loans based at least in part on the associated default risks; and
grouping the loans into a loan package having ownership rights that make the loan package operable as a transferable financial instrument.

10. The method of claim 9, further comprising disbursing requested funds to the professional service provider with proceeds from the loan.

11. The method of claim 10, further comprising receiving funds from the third party as repayment of the disbursed requested funds.

12. The method of claim 9, wherein forming the agreement between at least one lender and at least one third party includes forming a loan agreement.

13. The method of claim 9, wherein funding for professional services includes funding for legal services.

14. The method of claim 9, wherein determining the default risk to associate with each of the loans includes determining an amount of a security interest securing each of the loans.

15. The method of claim 9, further comprising securing at least one of the loans with a security interest perfected by the lender independent of the professional service provider.

16. The method of claim 9, wherein determining the price point for each of the loans includes determining a sale value for each of the loans.

17. The method of claim 9, wherein grouping the loans into the loan package includes forming the loans into a transferable financial instrument.

18. The method of claim 9, wherein grouping the loans into the loan package includes grouping the loans as collateralized debt obligations.

19. The method of claim 9, further comprising negotiating a discount term sheet for an amount of funds payable to the professional service provider by the lender.

20. The method of claim 9, wherein grouping the loans into the loan package having ownership rights includes grouping the loans into the loan package having ownership and participation rights.
